(19) United States
(12) Patent Application Publication
(10) Pub. No.: US 2026/0038381 A1
(43) Pub. Date: Feb. 5, 2026

(54) DYNAMIC CURRICULUM GRAPH UTILIZATION SYSTEM AND A METHOD THEREOF

(71) Applicant: 2hr Learning, Inc., Austin, TX (US)

(72) Inventors: Vicky Biswas, Dehradun (IN); Vinayak Sachdeva, Haryana (IN); Quintus Lamar, Atlanta, GA (US); Jenish Monpara, Surat (IN); Samyak Samdariya, Maharashtra (IN); Nitish Bharti, Bihar (IN)

(73) Assignee: 2hr Learning, Inc., Austin, TX (US)

(21) Appl. No.: 19/177,482

(22) Filed: Apr. 11, 2025

Related U.S. Application Data
(60) Provisional application No. 63/633,002, filed on Apr. 11, 2024.

(51) Int. Cl. G09B 5/02; G06Q 50/20; G09B 7/00

(52) U.S. Cl. CPC G09B 5/02; G06Q 50/20; G09B 7/00

(57) ABSTRACT

A curriculum graph database environment includes a curriculum graph database providing access to granular concepts covered in one or more curriculum. A user accesses the graph database via a user interface of an online learning platform. The graph database includes a curriculum graph generator that parses one or more curriculum data to identify a plurality of concepts, where each concept represents a concept node. The curriculum graph generator maps one or more learning resources included in the graph database to one or more related concept nodes. The user provides his inputs to the graph database, via the user interface, to retrieve a learning path related to a selected learning topic that he wants to master. The graph database includes a learning path generator that generates a learning path including list of concept nodes and associated learning resources to be completed by the user to attain mastery in the selected topic.

### CROSS-REFERENCE TO RELATED APPLICATION

This application claims the benefit under 35 U.S.C. § 119(e) and 37 C.F.R. § 1.78 of U.S. Provisional Application No. 63/633,022, filed Apr. 11, 2024, which is incorporated by reference in its entirety.

### FIELD OF THE INVENTION

The present invention relates in general to the field of electronics, and more specifically to generating dynamic curriculum graphs based on educational standards and learning resources.

### BACKGROUND OF THE INVENTION

In the current dynamic educational environment, there is an unprecedented demand for tailored and impactful learning experiences. Traditional educational systems often struggle to adapt to the diverse needs and learning styles of individual students. Additionally, the abundance of educational resources available, ranging from textbooks to online courses and interactive media, presents both opportunities and challenges in delivering tailored educational content.

Recognizing these challenges, there has been a growing interest in providing technology to enhance the educational experience. One promising avenue is the utilization of data-driven approaches to map educational concepts at different levels and create interconnected representations of educational content. This approach aims to provide educators and learners with a comprehensive view of curriculum standards, learning objectives, and available resources, thereby facilitating more effective teaching and learning strategies.

The concept of such mapping represents a significant paradigm shift in education, moving away from linear, static curricula towards dynamic, interconnected models that reflect the complex relationships between educational concepts. Traditional curriculums often sequentially present educational content, with topics arranged in a predetermined order. However, this approach may not fully capture the inherent connections and dependencies between different concepts, leading to fragmented learning experiences for students.

Furthermore, conventional educational platforms lacked the flexibility to dynamically access and update learning resources. They were often rigid in structure, making it difficult to integrate various types of educational materials and to adapt to the evolving needs of learners and educators. The retrieval of educational content was also limited, with platforms providing basic search and navigation functionality.

### SUMMARY

At least some embodiments of method and a corresponding system include: initializing a graph database providing access to one or more curriculum data and one or more learning resources;
generating one or more curriculum graphs using a curriculum graph generator, wherein generating one or more curriculum graphs using a curriculum graph generator comprises:
parsing one or more curriculum data to identify a plurality of concepts, wherein each concepts is represented as a concept node and set of related concept nodes are represented as edges;
   mapping the one or more learning resources to the plurality of concepts, wherein the learning resources correlated to one or more concepts are mapped to the corresponding one or more concept nodes;
   creating new concept nodes if new concepts are identified in the curriculum data or new curriculum data is provided, wherein the new concept nodes are mutually exclusive to the already created concept nodes;
   correlating the learning resources to the new concept nodes and dynamically mapping the learning resources to the related one or more new concept nodes;
receiving a user input to select a learning topic including selection of at least a start concept and a goal concept related to the topic;
generating a learning path including a list of concept nodes connecting the corresponding start concept node to the goal concept node along with a list of learning resources attached to the corresponding concept nodes in the learning path, wherein the one or more learning resources associated to the concept nodes are to be completed by the user to attain mastery in the selected learning topic.

### BRIEF DESCRIPTION OF THE DRAWINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

FIG. 1 depicts an exemplary curriculum graph database environment.

FIG. 2 depicts an exemplary curriculum graph database process.

FIG. 3 depicts a flowchart disclosing details of steps involved in utilization of the curriculum graph.

FIGS. 4 and 5 depict exemplary curriculum graphs.

FIG. 6 depicts an exemplary curriculum graph created for a mathematics book.

FIGS. 7-8 depict curriculum graphs that are generated using different educational standards.

FIG. 9 depicts a curriculum graph which is generated by integrating curriculum graphs of FIGS. 7 and 8 using the process of FIG. 2.

FIG. 10 depicts an exemplary network environment in which the system of FIG. 1 and the process of FIG. 2 may be practiced.

FIG. 11 depicts an exemplary computer system.

### DETAILED DESCRIPTION

A curriculum graph database environment includes a graph database and an online learning platform. The graph database can be accessed by a user via the online learning platform. The graph database include one or more curriculum graphs representing concepts covered in one or more educational standards including Common Core State Standards (CCSS), Next Generation Science Standards (NGSS), Advanced Placement (AP), and so on. Each curriculum graph includes a plurality of concept nodes representing unique concepts covered in a curriculum. Two or more related concept nodes are connected via edges, thereby forming an interconnected and navigable structure. The curriculum graph also includes one or more learning resources that can be chapters from textbooks, articles, videos, online courses, and other form of educational content in a digital format. The learning resources are mapped to one or more concept nodes based on relevance of resources to corresponding concept nodes. The curriculum graph database environment thus provides a custom-designed structure having granular concept mapping based on curriculums taught and the learning resources available.

The curriculum graph database environment provides access to one or more curriculum data and one or more learning resources stored in the graph database. The curriculum graph database environment incudes a curriculum graph generator for generating one or more curriculum graphs. The curriculum graph generator includes a parsing module and a mapping module. The parsing module parses the curriculum data to identify the plurality of concept nodes and the mapping module maps one or more learning resources to related one or more concept nodes. The curriculum graph generator also create new concept nodes for any new concepts or topics that are added to the curriculum, and correlated the learning resources to the new concept nodes for dynamic mapping of the learning resources to the related concept nodes. curriculum graph generator uses natural language processing techniques to analyze the one or more curriculum data and learning resources for mapping and creation of curriculum graphs. More specifically, curriculum graph database environment uses natural language processing techniques to identify one or more curriculum units included in the curriculum data, analyzes each curriculum unit to identify unique concepts, and then create concept nodes for each identified concept if the node is not already created. The curriculum graph database environment also identify prerequisite concepts that are related to one or more identified concepts. The prerequisite concepts are connected to corresponding concepts via edges showing relationship between the prerequisite concepts and the concepts.

The curriculum graph database environment further includes a learning path generator configured to process the curriculum graph and create a learning path based upon user's inputs. The user provide his inputs related to a learning topic via the user interface of the online learning platform. The user input include a start concept and a goal concept related to the learning topic that the user is interested in mastering. The learning path generator takes user inputs and identify a list of concept nodes connecting the start concept to the goal concept, thereby generating a learning path for the user. The learning path generator also extract list of learning resources associated to the corresponding concepts. The learning resources associated with the concept nodes are to be completed by the user to attain mastery in a selected topic.

The curriculum graph database environment navigates the learning path by employing a multifaceted approach to optimize the user's learning journey. Firstly, it determines a chronological order of one or more corresponding learning resources within the path, ensuring a structured progression. Subsequently, it dynamically adjusts the sequence of presented resources based on the user's interaction and progress, tailoring the experience to individual needs. By using machine learning techniques, it continuously analyzes the user's learning trajectory, adapting to their evolving proficiency level.

The curriculum graph database environment offers several advantages significantly enhancing the teaching and learning experience. By integrating one or more curriculum standards and one or more learning resources into a coherent structure, the curriculum graph provides a comprehensive and interconnected representation of educational content, enabling users to explore concepts deeply and master various concepts included in the educational standards. The granular concept mapping of graph database facilitates personalized learning, allowing users to navigate the curriculum with precision. The use of online learning platforms to display the curriculum graph as a navigation tool and its flexible API empowers users to retrieve interconnected data tailored to their needs, fosters exploration and customization in learning.

Additionally, the curriculum graph database environment further includes content upgradation, assessment, and feedback reporting mechanisms. The environment provides valuable insights into user interactions and learning outcomes, enabling instructors to monitor user's progress and adapt teaching strategies for improved engagement and outcomes. Thereby, allowing users to understand his/her learning level i.e., whether he/she can master that particular topic or not. Overall, the curriculum graph revolutionizes traditional educational practices, offering a comprehensive, personalized, and data-driven learning experience across diverse educational settings.

While the curriculum graph database environment presented herein makes use of specific reference to dynamic curriculum graph database integrated along with the online learning platform for the students, it is to be appreciated that the description is also equally applicable for school teachers, parents teaching their child at home, student doing self-tutoring, coaching tutors, adults learning for their career development, employees in corporate training, parents for parenting education, children for craft, music and other education, elderly people for medical guidance, medical staff for guidance, and so on. The curriculum graph database environment is for any user who wishes to have mastery in any learning topic.

Furthermore, the online learning platform disclosed in the curriculum graph database environment may include any suitable online learning platform, e-learning platform, virtual learning platform, web-based learning platform, internet-based study platform, remote learning platform, web education platform, education platform study platform and so on.

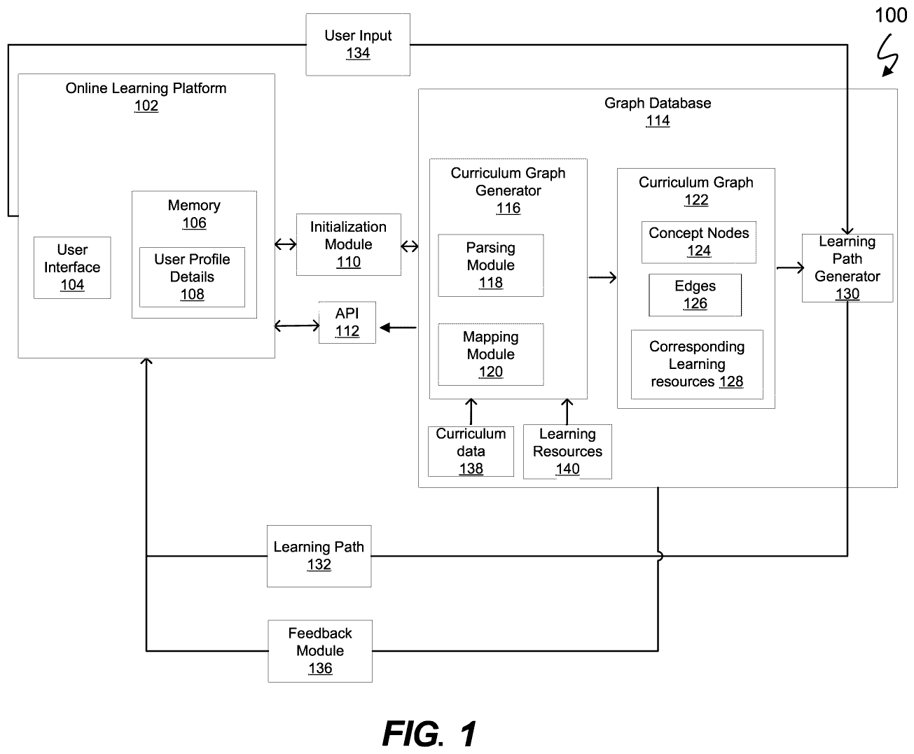

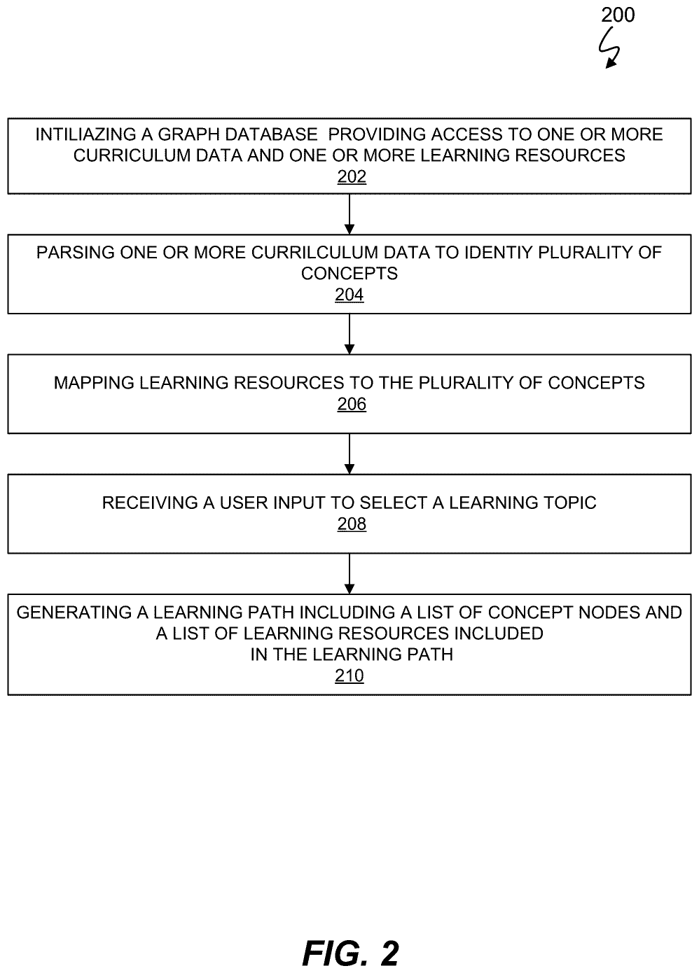

FIG. 1 depicts an exemplary curriculum graph database system 100. FIG. 2 depicts an exemplary curriculum graph database process 200 utilized by the curriculum graph database system 100.

Referring to FIGS. 1 and 2, in operation 202 an initialization module 110 initializes a graph database 114 providing access to one or more curriculum data 138 and one or more learning resources 140. The initialization module can be a web extension or driver establishing connection between an online learning platform 102 and the graph database 114. The curriculum graph 122 in graph database 114 focuses on mastery-based learning of the user. The curriculum graph 122 details dependencies and connections between content in one or more curriculum, allowing for targeted content retrieval that aligns with related material for comprehensive learning outcomes. The curriculum topics are encapsulated within a graph data structure, functioning as a graph database 114. The one or more concept nodes 124 signifies a topic, and the one or more edges 126 outline the relationships between them, including progression and prerequisites. The curriculum data 138 is aligned to one or more educational standards including Common Core State Standards (CCSS), Next Generation Science Standards (NGSS), Advanced Placement (AP), and so on which houses comprehensive details of each topic included in these curriculum. The graph represents an educational topic such that the curriculum graph includes one or more concept nodes 124 related to the educational topic and related concept nodes 124 are joined through edges 126 thereby allowing navigation between connected concept nodes. One or more learning resources 140 comprises textbooks, chapters, articles, videos, audio content, and online courses. One or more nodes are created within a graph database 114 to represent identified concepts which begins by establishing the graph database 114 structure capable of storing nodes and edges 126, followed by generating nodes to symbolize each concept. Subsequently, one or more edges 126 are established between one or more nodes to signify relationships between one or more concepts and one or more curriculum data 138, denoting dependencies or prerequisites. Through these steps, one or more concept nodes 124 are organized within the graph database 114 to facilitate effective knowledge representation and curriculum alignment.

The graph database 114 is configured to provide access to a diverse range of curriculum data 138, encompassing various educational topics, subjects, standards, and learning objectives which includes inputting information such as course outlines, learning outcomes, and educational standards into the graph database 114, ensuring comprehensive coverage of the curriculum data 138. Further, the graph database 114 is designed to accommodate one or more learning resources 140, which may include textbooks, articles, videos, interactive modules, and other instructional materials relevant to the curriculum.

During the process of initialization, it is ensured that the graph database 114 is connected to the online learning platform 102. The graph database 114 is structured to represent data in the form of concept nodes 124 and edges 126. Each concept node 124 corresponds to a specific concept, topic, or learning objective within the curriculum, while edges 126 denote relationships or connections between these nodes. These relationships may signify dependencies, prerequisites, correlations, or hierarchical associations between different concepts or learning elements. Furthermore, the initialization process involves organizing and categorizing one or more curriculum data 138 and one or more learning resources 140 within the graph database 114, ensuring logical organization and efficient retrieval of information. This may include tagging resources with metadata, categorizing content based on subject areas or educational levels, and establishing hierarchies or taxonomies to facilitate navigation and search functionalities.

In operation 204, a curriculum graph generator 116 generates one or more curriculum graphs 122 using a parsing module 118 and a mapping module 120. The curriculum graph generator 116 takes the input data from one or more curriculum data 138 and one or more learning resources 140 and based on this generates one or more curriculum graphs 122. The curriculum graph generator 116 utilizes advanced machine learning algorithms and natural language processing techniques to generate one or more curriculum graphs 122. Based on the dynamic functionality, the curriculum graph generator 116 not only structures educational content but also fosters a cohesive and navigable learning environment. By utilizing the curriculum graph generator 116 capabilities, users can access tailored learning paths, optimize their educational journeys, and achieve mastery in their chosen subjects.

The parsing module 118 parses one or more curriculum data 138 to identify a plurality of concepts such that each of the plurality of concepts are represented as nodes, and a set of related nodes are connected via edges 126. The parsing module 118 further analyzes the content of each curriculum data 138 using natural language processing techniques to identify one or more curriculum units and analyzes each curriculum unit to identify unique concepts, thereby creating a node for each identified concept if the node is not already created. The prerequisite concepts are then identified and new nodes are created for unique prerequisites which helps in creating an edge 126 between the prerequisite concept to the corresponding concept. The parsing module 118 then converts the parsed curriculum data 138 into a structured format by breaking down the content of curriculum data into granular concept nodes. The parsing module 118 identifies one or more synonyms and related terms for the identified concepts nodes 124 to enhance concept coverage and understanding. The identified concept nodes 124 are standardized to ensure consistency and accuracy in the representation of one or more curriculum data 138. Then a prerequisite relationship is generated between one or more concept nodes 124 to expand the curriculum graph 122.

In operation 206, the mapping module 120 maps one or more learning resources 140 to the plurality of concepts. The learning resources 140 correlated to one or more concepts are mapped to the respective concept nodes 124 and one or more new concept nodes are created for the remaining learning resources that are not correlated to any of the existing concept nodes. The mapping module 120 identifies one or more relevant learning resources 140 which establishes the connection between one or more learning resources 140 and corresponding concept nodes 124 within the graph database 114 by linking resources to nodes representing related one or more concept nodes 124.

As part of the one or more curriculum graph 122 generation process, the mapping module 120 establishes a seamless connection between identified one or more concept nodes 124 and the diverse array of one or more corresponding learning resources 128. The mapping module 120 ensures by correlating one or more corresponding learning resources 128 with their corresponding one or more concept nodes 124, that educational materials are strategically aligned with specific learning objectives. Through this mapping process, users can easily navigate through the curriculum graph 122, accessing one or more corresponding learning resources 128 tailored to their educational needs and interests. Additionally, the mapping module 120 dynamically generates new concept nodes for learning resources that lack direct associations, thereby enriching the depth and breadth of the curriculum graph and providing users with a comprehensive learning experience.

In operation 208, a user interface 104 integrated within the online learning platform 102 allows users to provide a user input 134 to a learning path generator 130. The user input 134 includes at least a start concept and a goal concept related to a learning topic that the user wishes to master. The user interface 102 also allows users to access various other data which include learning objectives, one or more user preferences, the progress status of a user, one or more feedback, and so on. The online learning platform 102 represents a centralized hub for accessing one or more content, resources, and tools in a digital format. The user interface 104 provides users and instructors with a convenient and flexible platform for engaging in remote learning, accessing course materials, and collaborating with peers and educators. For example, students can log into the online learning platform 102 from any internet-enabled device to access lectures, textbooks, assignments, and interactive learning activities. Instructors, on the other hand, can use the online learning platform 102 to deliver lectures, administer assessments, track student progress, and provide feedback.

The user may log into the online learning platform 102 using any suitable computing device including mobile, computer, tablet, laptop, and so on. The user accesses and interacts with the online learning platform 102 via user interface 104 having an integrated chatbot (not shown in the figure). The user profile details 108 are stored in memory 106. The user profile details 108 include a variety of information related to the user, such as demographic data (e.g., age, gender, location), educational background, areas of interest, learning preferences (e.g., visual, auditory), and performance data (e.g., quiz scores, completion rates, understanding skills). The online learning platform 102 collects and analyzes the user profile details 108 and dynamically adapts its content, recommendations, and learning pathways to align with each user's profile. For example, if a user demonstrates proficiency in certain concepts, the online learning platform 102 may suggest more advanced concepts or topics to challenge the user further. Conversely, if a user struggles with specific concepts, the online learning platform 102 may provide additional learning resources or remedial content to support their learning. The user profile details 108 also play a crucial role in tracking and monitoring user's progress over time. By recording data such as quiz scores, completion rates, and time spent on tasks, the online learning platform 102 can generate insights into individual learning trajectories and identify areas for improvement. Instructors and administrators can use this data to provide targeted interventions, offer personalized feedback, and make informed decisions about curriculum development and instructional strategies.

The user interface 104 allows users to access the online learning platform 102 provide their inputs and receive a response whenever required. The user interface 104 plays a vital role in facilitating user interaction with the online learning platform 102. The user interface 104 serves as a bridge between the online learning platform 102 and the graph database 114, providing a user-friendly environment for the utilization of the graph database 114. The user interface 104 is designed to be intuitive, visually accessible, and conducive to a seamless user experience. The user interface 104 is thoughtfully designed to be visually appealing and easy to navigate, ensuring that users can effortlessly input their preferences.

The user interface 104 encompasses various elements, including navigation menus, search bars, content displays, and interactive components, designed to facilitate seamless user engagement and navigation. For example, the user interface 104 may feature intuitive navigation pathways that allow users to easily browse through different courses, topics, and learning resources. Additionally, interactive elements such as quizzes, simulations, and multimedia presentations may be incorporated into the user interface 104 to enhance user engagement and interactivity.

In operation 210, the learning path generator 130 generates a learning path 132 which includes a list of one or more concept nodes 124 connecting the start concept node to the end concept node along with a list of one or more corresponding learning resources 128 attached to the corresponding concepts nodes 124 in the learning path 132. The one or more corresponding learning resources 128 associated with the concept node 124 are to be completed by the user to attain mastery in the selected learning topic.

The one or more learning path 132 is navigated by determining a chronological order of the one or more learning resources 128 within a learning path 132. The sequence of one or more learning resources 128 is dynamically adjusted and is presented to the user based on the user's interaction and progress within one or more learning paths 132. The machine learning techniques are used to analyze the user's learning progress and automatically select and present additional one or more corresponding learning resources 128 based on the user's learning level, thereby facilitating comprehensive understanding and mastery of the selected topic.

The learning path generator 130 is a crucial component of the graph database 114, using a structured learning path 132 for users to navigate towards mastery in their chosen topic. Through a series of operations, the learning path generator 130 constructs a learning path 132 that connects the start concept node to the end concept node within the curriculum graph 122. Each concept node 124 along this path represents a fundamental concept or learning objective, guiding users through the essential components of the selected topic. Additionally, the learning path 132 generator associates a curated list of learning resources with each concept node 124, providing users with the necessary materials to engage with and master the associated concepts.

For instance, let's consider a user interested in learning about multiplication. The learning path generator would begin by identifying the start concept node, perhaps ‘One Digit Multiplication,’ and the end concept node, such as ‘Three Digit Multiplication.’ It then constructs a pathway by connecting the nodes, including prerequisite concept nodes like ‘Two Digit Addition,’ ‘Three Digit Addition,’ and ‘One-Digit Multiplication.’ Alongside each concept node 124, the curriculum graph generator 116 attaches a list of one or more corresponding learning resources 128, such as articles, videos, interactive simulations, and quizzes, tailored to facilitate understanding and skill acquisition in each concept area.

As the user progresses along the learning path 132, the sequence of one or more corresponding learning resources 128 is dynamically adjusted based on their interaction and progress. Machine learning techniques analyze the user's learning trajectory, adapting the presentation of resources to their individual learning level and preferences. For example, if a user demonstrates proficiency in understanding ‘One Digit Multiplication’ but struggles with ‘Three Digit Multiplication’, the learning path generator 130 may prioritize additional resources related to ‘Three Digit Addition’ to address the user's learning gaps and enhance their comprehension of the topic.

Through this iterative process, the learning path generator 130 optimizes the user's educational journey, providing personalized guidance and support to facilitate comprehensive understanding and mastery of the selected topic. By leveraging curated learning paths 132 and adaptive resource selection, users can navigate through complex subject matter with confidence and achieve their learning goals effectively.

An API (application programming interface) 112 facilitates access to the graph database 114 based on query mechanisms for users to retrieve content based on one or more concept nodes 124 and curriculum standards 138 which further enables navigation of content through user interface 104. The API 112 of the curriculum graph database system 100 serves as a bridge for enabling communication and data exchange between different components and external systems. The API 112 also enables communication and data exchange between the online learning platform 102 and graph database 114. The API 112 allows developers to access and integrate platform functionalities into third-party applications, tools, and services. The metadata is incorporated within the graph database 114 to describe the nature and format of the one or more corresponding learning resources 128 for effective retrieval.

The curriculum graph database system 100 also evaluates the learning outcomes of the user based on various quizzes, tests, and assignments to monitor the comprehension and mastery of one or more concept nodes 124. Based on the assessment results the reports are generated and displayed on the user interface 104. If the user fails to master one or more concepts 124 some remediation strategies are provided to the user to support his/her learning journey. Utilizing the detailed curriculum graph 122, user profile data 108, and user assessment result, the curriculum graph database system 100 dynamically adjusts the learning experience to accommodate the user's needs. Remediation may involve modifying the level of difficulty of the content by either decreasing the complexity of the concepts 124 or providing easier questions to reinforce understanding. For instance, if a student struggles with a particular concept, the curriculum graph database system 100 may offer supplementary resources, such as additional explanations, practice exercises, or interactive tutorials targeted at addressing the specific learning gaps identified. By adapting the learning content and resources in response to the user's performance, the online learning platform 102 promotes a supportive and personalized learning environment, ultimately facilitating greater comprehension and mastery of the educational material.

The below pseudo-code represents exemplary utilization of a curriculum graph database by the “curriculum graph database system 100”:

```
  initializeGraphDatabase( ):
    Connect to graph database
    If connection is successful:
      Print “Database connection successful”
    Else:
      Print “Database connection failed”
      Exit
  parseCurriculumData(curriculum):
    For each curriculum_unit in curriculum:
      For each concept in curriculum_unit:
        Create node for concept if it doesn't already exist
in graph
        For each prerequisite_concept in
concept.prerequisites :
          Create node for prerequisite_concept if it
doesn't already exist
          Create directed edge from prerequisite_concept to
concept
    Print “Curriculum data parsing and graph population
completed”
  mapLearningResourcesToConcepts(learning_resources):
    For each resource in learning_resources:
      For each concept in resource.concepts_covered:
        If node for concept exists in graph:
          Attach resource to concept node as a property
        Else:
          Print “Concept node missing for resource mapping”
    Print “Learning resources mapped to concepts”
  generateLearningPath(start_concept, goal_concept):
    Initialize empty list for learning path
    Use graph database query to find all paths from start_concept
to goal_concept
    Select the shortest path or the path that fits the student's
learning style/preferences
    For each concept_node in selected path:
      Append concept_node to learning path
    Return learning path
  navigateLearningPath(learning_path):
    For each concept in learning_path:
      Display concept information
      Display list of learning resources attached to concept
      Input user_progress
      If user_progress indicates concept mastery:
        Continue to next concept
      Else:
        Offer remediation resources
        Re-attempt current concept
  main( ):
    # Initialization and data parsing
    initializeGraphDatabase( )
    curriculum_data = loadCurriculumData( ) # Assume method to
load data exists
    learning_resources = loadLearningResources( ) # Assume method
to load data exists
    parseCurriculumData(curriculum_data)
    mapLearningResourcesToConcepts(learning_resources)
    # User interaction for learning path generation
    start_concept = getUserInput(“Enter start concept”)
    goal_concept = getUserInput(“Enter goal concept”)
    learning_path = generateLearningPath(start_concept,
goal_concept)
    # Navigate learning path
    navigateLearningPath(learning_path)
  main( )
```

In an embodiment, the curriculum graph database system 100 includes a feedback module 136 that collects feedback based on user inputs related to progress made on concepts included in the learning path or other related inputs. The collected feedback serves as a vital tool for fostering continuous improvement and enhancing the overall learning experience. The feedback module 136 collects user's feedback on various aspects to the online learning platform 102, including course content, instructional materials, user interface 104 design and so on. For instance, users may offer insights on the clarity and relevance of the learning resources, the effectiveness of instructional methods, and the usability of the user interface. The curriculum database 114 then utilize this feedback to identify areas for enhancement and refinement.

In an embodiment, the curriculum graph database system 100 generates recommendations for the user using advanced algorithms. The recommendations are generated based on various factors, such as a user's past interactions with the online learning platform 102 using user interface 104, performance on assessments, and stated learning objectives, to generate tailored recommendations that align with their individual needs and preferences. For example, based on a user's demonstrated proficiency in certain concepts and areas of interest, the recommendation generated may include advanced supplementary learning resources including specialized courses to further deepen user's understanding. Similarly, if the user struggles on specific concept nodes 124, the recommendations may also include remedial resources or interactive activities designed to reinforce key concepts. By providing targeted recommendations, the online learning platform 102 empowers users to explore new topics, expand their knowledge base, and achieve their learning goals more efficiently.

The recommendations are generated based on analysis of the user interaction with the user interface 104 for tracking user's progress and performance metrics to adapt one or more personalized recommendations based on individual learning styles and abilities by utilizing natural language processing techniques to interpret one or more user queries and refine search results for content retrieval.

In an embodiment, the curriculum graph database system 100 the content upgradation plays a crucial role in ensuring that one or more concepts nodes 124 remains relevant, accurate, and up-to-date on a real time basis within the online learning platform 102. The curriculum graph database system 100 continuously reviews one or more curriculum standards 138 and one or more learning resources 140 and thereby updates one or more concepts nodes 124, and one or more corresponding learning resources 128. For example, if new research findings, industry developments, new syllabus add-ons, new videos on any topic covering different concepts and so on, the curriculum graph database system 100 can prompt revisions to one or more concepts nodes 124, and one or more corresponding learning resources 128 to incorporate the new information. Similarly, if changes occur in one or more curriculum data 138, the curriculum graph database system 100 ensures that the curriculum graph 122 remains compliant and aligned for the user. The upgradation occurs using machine learning algorithms to dynamically adjust the structure of the curriculum graph 122 based on the user interactions and feedback. By proactively managing content upgradation, the online learning platform 102 enhances the quality and currency of its educational offerings, providing users with a comprehensive and cutting-edge learning experience.

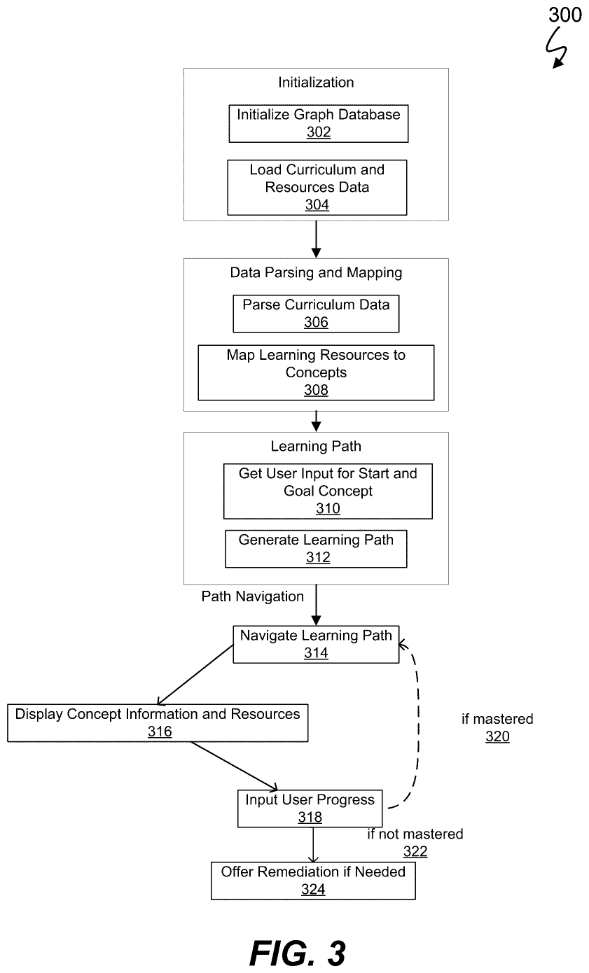

FIG. 3 depicts a flowchart 300 disclosing details of steps involved in the process of utilization of a curriculum graph.

The graph database 114 is initiated 302 by providing access 304 to one or more curriculum data 138 and one or more learning resources 140. One or more curriculum graphs 122 are stored in the graph database 114 which includes one or more concept nodes 124, one or more edges 126, and one or more corresponding learning resources 128. In the curriculum graph 122, the one or more edges 120 represents relationships between one or more concept nodes 124 and one or more curriculum data 138. The one or more curriculum data 138 is aligned to one or more educational standards including Common Core State Standards (CCSS), Next Generation Science Standards (NGSS), and Advanced Placement (AP). The one or more corresponding learning resources 128 disclosed here include textbooks, articles, videos, or online courses, and one or more content is received in a digital format.

The curriculum graph generator 116 generates the one or more curriculum graph 122 using the parsing module 118 and mapping module 120. The parsing module 118 parses 306 the one or more curriculum data 138 to identify a plurality of concepts and the mapping module 120 maps 308 the one or more learning resources 140 to the plurality of concept nodes 124. The one or more corresponding learning resources 128 correlated to one or more concepts 124 are mapped to the respective concepts and one or more new concept nodes are created for the remaining learning resources that are not correlated to any of the existing concept nodes 124.

The user interface 104 allows the user to provide 310 the user input 104 to the learning path generator 130. The user input 104 includes at least a start concept and a goal concept related to a topic the user wishes to master. A learning path 132 is generated 312 based on the user input 104 through the learning path generator 130.

The one or more learning path 132 for the user is navigated 314 and displayed 316 to the user 316 on the online learning platform 102. The various quizzes, tests, and assignments evaluate user comprehension and mastery 320 of one or more concept nodes 124. If the user fails to master one or more concepts 322 some remediation strategies 324 are provided to the user to support his/her learning journey. The feedback module 132 continuously monitors the user's performance and comprehension level across one or more concept nodes 124 and corresponding learning resources 128 and provides feedback based on the same.

Utilizing the detailed curriculum graph 114, user profile details 108, and user assessment result, the curriculum graph database system 100 dynamically adjusts the learning experience to accommodate the user's needs. Remediation strategies involve modifying the level of difficulty of the content by either decreasing the complexity of the concepts 124 or providing easier questions to reinforce understanding. For instance, if a student struggles with a particular concept, the curriculum graph database system 100 may offer supplementary resources, such as additional explanations, practice exercises, or interactive tutorials targeted at addressing the specific learning gaps identified.

The above-discussed steps 322 and 324 would be clearer with the help of the following examples:

### Example 1: When the User, Say a Student, Masters a Concept

Emily, a Grade 5 student, is using the online learning platform 102 to study photosynthesis for her biology class through engaging with various learning materials, including videos, interactive simulations, and practice quizzes. Emily demonstrates a strong grasp of the concept. Emily consistently performs well on assessments, scores high marks on quizzes, and demonstrates a deep understanding of the topic of photosynthesis on all the quizzes, and tests. Based on the assessment report Emily provided on the online learning platform 102 displays Emily's mastery of the topic.

### Example 2: When the User, Say a Student, Fails to Master a Concept and is Struggling Hard to Understand the Concept

Richard, a Grade 7 student of physics class, is having difficulty grasping the concept of electrical machines. Despite multiple attempts to engage with the concepts, Richard continues to struggle with understanding the electrical machine and its working mechanism. Recognizing Richard's challenges, the online learning platform 102 adjusted his recommendations to provide additional support. Firstly, the complexity of questions presented to Richard is reduced by offering simpler, more straightforward practice quizzes which are focussing on basic concepts and terminology. Secondly, the online learning platform 102 offered Richard access to supplemental one or more corresponding learning resources 128, such as tutorial videos, animated diagrams, and so on to reinforce his understanding of electrical machines. The learning path generator 130 generated the learning path for Richard i.e., before reaching out to a particular concept he has to cover the prerequisite subconcepts. Furthermore, the online learning platform 102 provides Richard with personalized feedback and explanations tailored to his specific misconceptions and areas of difficulty. By adapting the recommendations to meet Richard's needs and providing targeted support, the online learning platform 102 empowers him to overcome his struggles with the electrical machines and progress toward mastery of the concept.

By adapting the learning content and resources in response to the user's performance, the online learning platform 102 promotes a supportive and personalized learning environment, ultimately facilitating greater comprehension and mastery of the educational material.

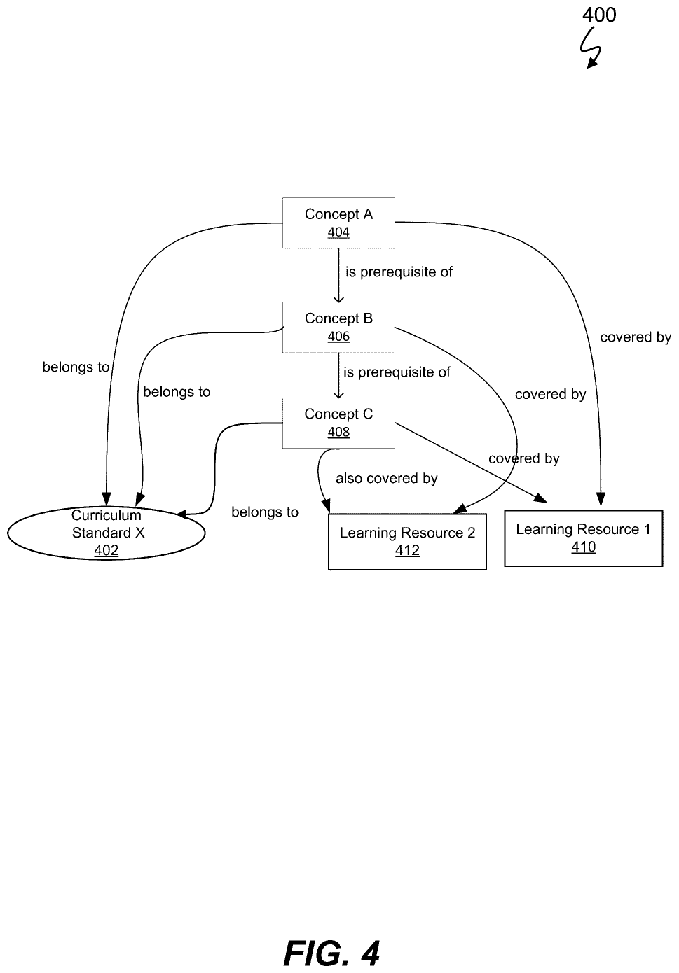

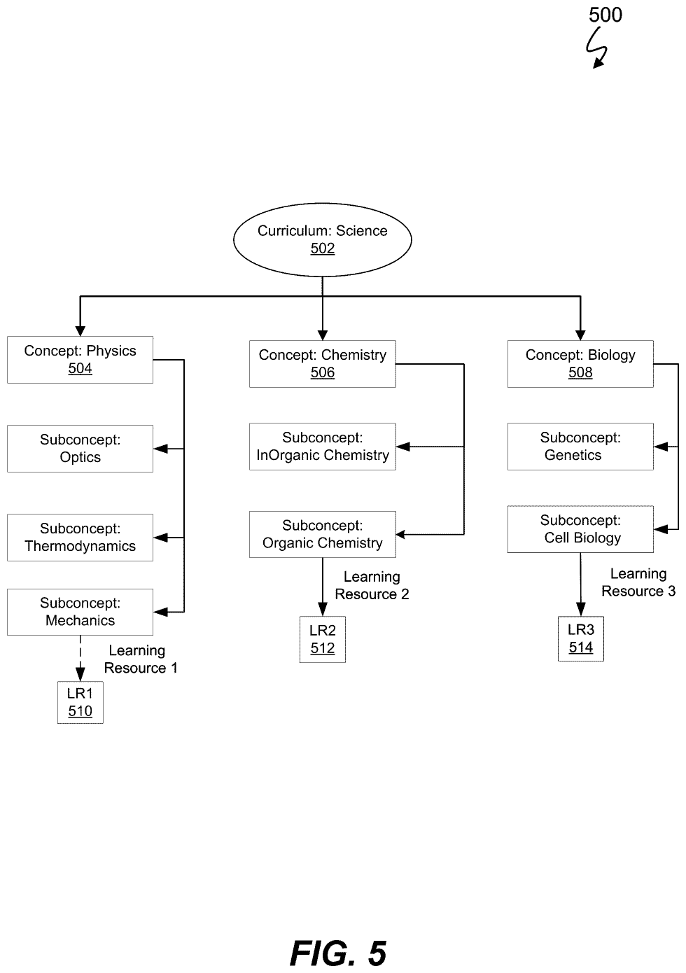

FIGS. 4 and 5 depict exemplary curriculum graphs 400 and 500.

The curriculum graph 400 shown in FIG. 4 is made using ‘Curriculum Standard X’ 402. The ‘Concept A’ 404, ‘Concept B’ 406, and ‘Concept C’ 408 are part of the ‘Curriculum Standard X’ 402. The data present in the ‘Learning Resource 1’ 410 is mapped to ‘Concept A’ 404 and ‘Concept C’ 408. On the other hand, the data present in ‘Learning Resource 1’ 410 and ‘Learning Resource 2’ 412 is mapped to ‘Concept B’ 406. This would be clear from an exemplary curriculum graph 500 shown in FIG. 5.

The curriculum graph 500 is a detailed curriculum graph that maps one or more learning resources to one or more concepts 124. This is just an exemplary scenario where one or more educational curricula are considered. In this case, the CCSS (Common Core State Standards) is chosen. Out of which, the topic ‘Science’ 502 is selected to make a curriculum graph. In general, one or more concepts extracted from the curriculum having topic 502 ‘Science’ includes ‘Physics’ 504, ‘Chemistry’ 506, and ‘Biology’ 508. All the concepts are further divided into sub-concepts i.e., the technical domain which is an integral part of the concepts. For example, the concept ‘Physics’ 504 includes sub-concepts like mechanics, optics, thermodynamics, and so on. Similarly, the concept ‘Chemistry’ 506 includes sub-concepts like organic chemistry, inorganic chemistry, and so on. In the case of the concept ‘Biology’ 508, the sub-concepts include cell biology, genetics, reproduction, and so on. The ‘Learning Resource 1’ 510, ‘Learning Resource 2’ 512, and ‘Learning Resource 3’ 514 maps the data within them to the sub-concepts. If the learning resources are connected to one or more concepts, then the learning resources will map their data directly to the concept.

The curriculum graph database system 100 ensures that the concepts remain relevant, accurate, and up-to-date on a real-time basis. For example, if there is a change in the curriculum like new topics are added or any new learning resource is captured by the graph database 114, the new topics and concepts will get added to the curriculum graph 500. The curriculum graph database system 100 ensures that the users have access to the latest advancements and best practices in their field of study by continuously reviewing and updating one or more curriculum data 138 and one or more corresponding learning resources 140. This proactive approach not only enhances the quality of the learning materials but also promotes adaptability and customization, ultimately leading to a more effective and engaging learning experience for users.

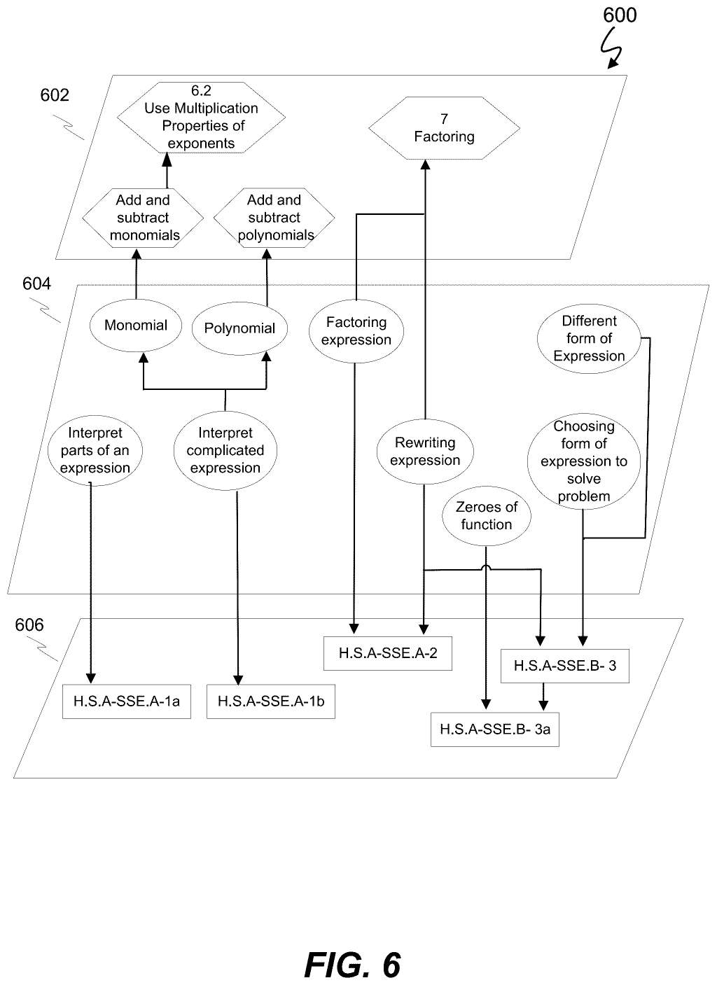

FIG. 6 depicts an exemplary curriculum graph 600 of a mathematics book.

The exemplary curriculum graph 600 of a mathematics book is shown here for a better understanding of the curriculum graph database process 200. The curriculum graph 600 is divided into three different sections, each of which is interconnected to each other. The curriculum graph 600 includes ‘Section A’ 602 i.e., a topic from a mathematics book (one or more chapters), ‘Section B’ 604 i.e., concepts and subconcepts, and ‘Section C’ 606 i.e., curriculum standards. Each section is interlinked to the other to generate the curriculum graph 600. Here the user can check his/her learning capabilities based on the given one or more topics and one or more concepts.

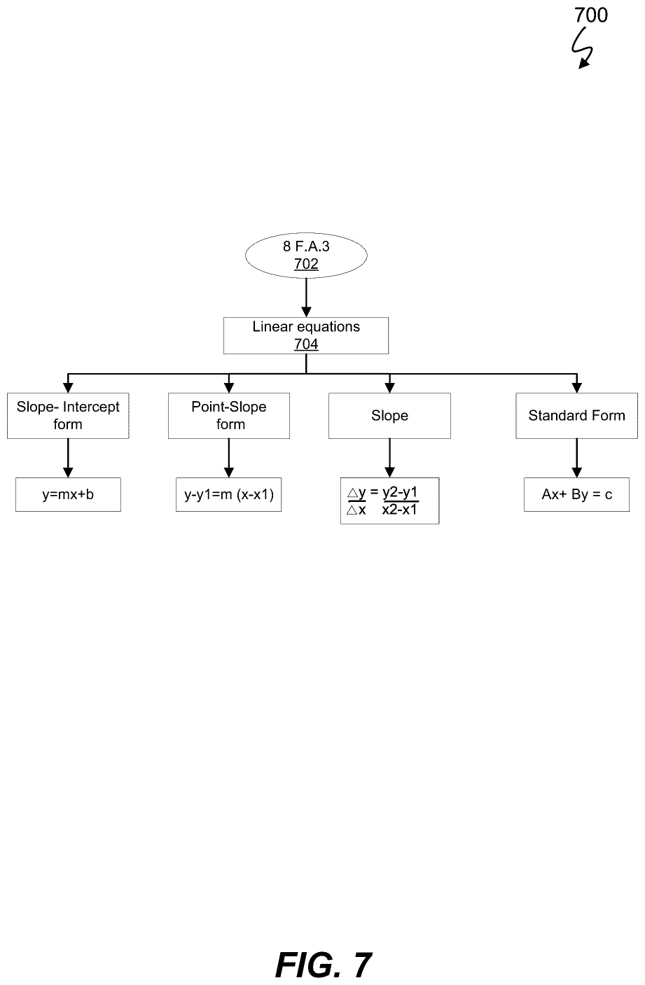

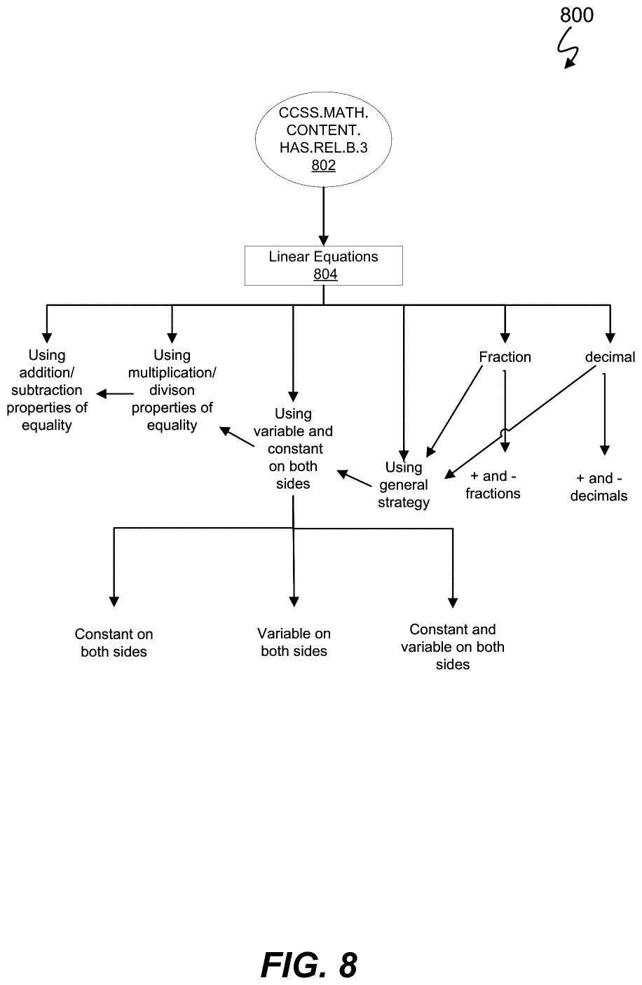

FIGS. 7-8 depict curriculum graphs 700 and 800 which are generated using different educational standards.

The curriculum graph 700 shown in FIG. 7 is generated using Next Generation Science Standards (NGSS) as an exemplary education standard 702. Here the topic 704 selected to generate the curriculum graph is ‘Linear Equations’. One or more concepts and sub-concepts are extracted from the education standard 702 and one or more learning resources respectively. This way the curriculum graph 700 is generated for the education standard 702.

The curriculum graph 800 shown in FIG. 8 is generated using CCSS (Common Code State Standards) as an exemplary education standard 802. Here the topic 804 selected to generate the curriculum graph is ‘Linear Equations’. One or more concepts and sub-concepts are extracted from the education standard 802 and one or more learning resources respectively. This way the curriculum graph 800 is generated for NGSS for education standard 702.

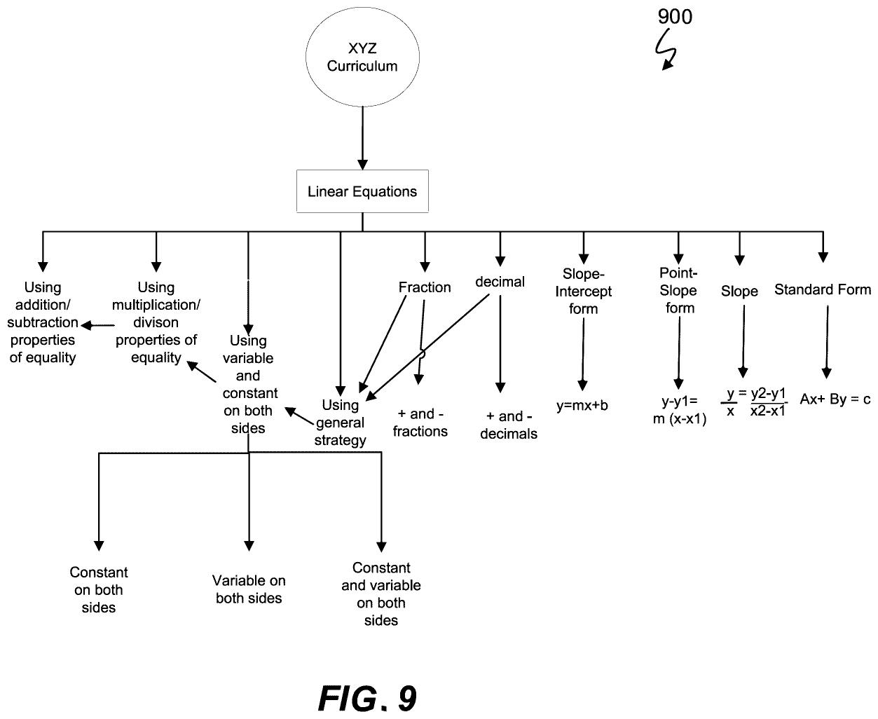

FIG. 9 depicts a curriculum graph 900 which is generated by integrating curriculum graphs 700 and 800 of FIGS. 7 and 8 using the process of FIG. 2.

The curriculum graph 900 is generated in a scenario, for instance, when new topics are added to the curriculum, a few old topics are removed, and so on. This is visible from the curriculum graphs 700 and 800 that the concepts covered under both curriculums 702 and 802 are different. To overcome the problem faced due to this situation and to provide all possible concepts to the user, the curriculum graph database system 100 helps in extracting all the concepts from one or more educational curriculums like CCSS 702, NGSS 802, and so on. One or more learning resources map the data to the corresponding one or more concepts. One or more learning resources include textbooks, articles, videos, or online courses.

The curriculum graph database system 100 keeps on upgrading the curriculum graph 900 on a real-time basis. The curriculum graph database environment ensures that the online learning platform 102 stays relevant by offering up-to-date information, improves quality through continuous review, enables adaptability by incorporating new findings, fosters collaboration among educators, and ultimately enhances the platform's effectiveness by keeping content relevant, high-quality, and adaptable.

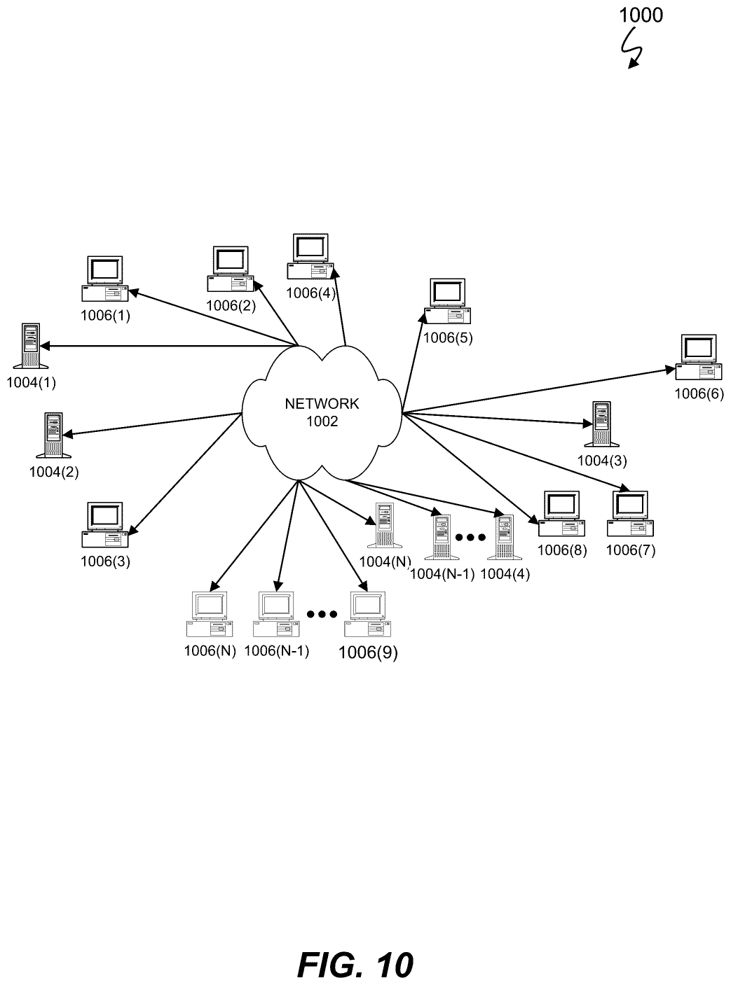

FIG. 10 is a block diagram illustrating a network environment in which a curriculum graph database system 100 and process 200 may be practiced. Network 1002 (e.g. a private wide area network (WAN) or the Internet) includes several networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example, communications channels providing T1 or OC3 service. Client computer systems 1006(1)-(N) typically access server computer systems 1004(1)-(N) through a service provider, such as an internet service provider (“ISP”) by executing application-specific software, commonly referred to as a browser, on one of client computer systems 1006(1)-(N).

Client computer systems 1006(1)-(N) and/or server computer systems 1004(1)-(N) are specialized computers programmed to improve conventional computer systems to implement and utilize the curriculum graph database system 100 and process 200. The type of computer system that can be specially programmed to implement and utilize the curriculum graph database system 100 and process 200 include a mainframe, a mini-computer, a personal computer system including notebook computers, a wireless, mobile computing device (including personal digital assistants, smartphones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the curriculum graph database system 100 and process 200 can be implemented using code stored in a tangible, non-transient computer-readable medium and executed by one or more processors. In at least one embodiment, the curriculum graph database system 100 and process 200 can be implemented completely in hardware using, for example, logic circuits and other circuits including field programmable gate arrays.

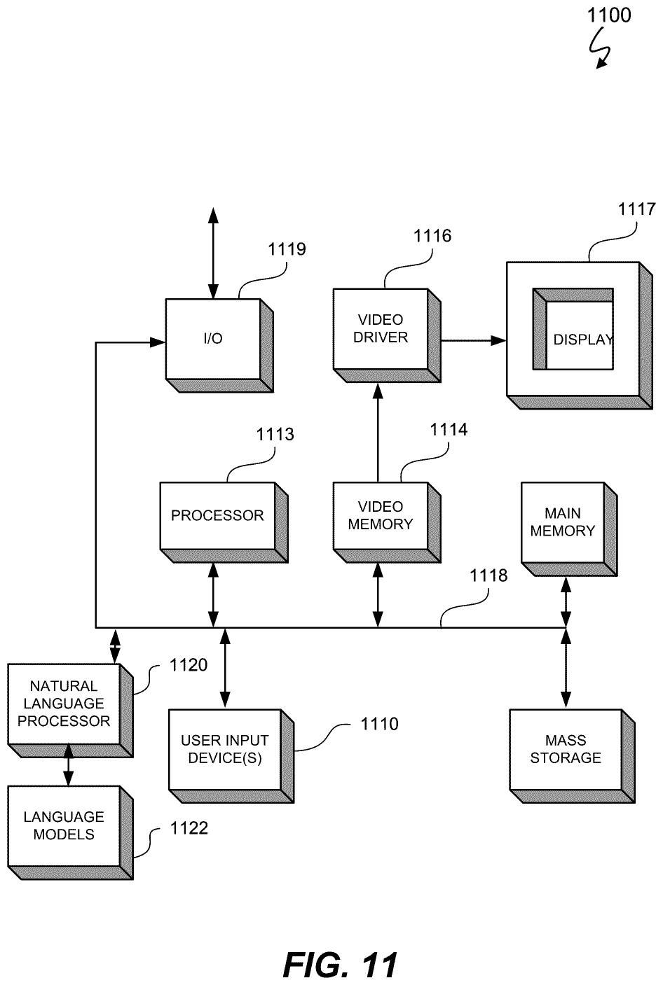

Embodiments of the curriculum graph database system 100 and process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer system via a telephone link or to the Internet via an ISP. I/O device(s) 1119 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to the video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The curriculum graph database system 100 and process 200 may be implemented in any type of computer system or programming or processing environment. It is contemplated that the curriculum graph database system 100 and process 200 might be run on a stand-alone computer system, such as the one described above. The curriculum graph database system 100 and process 200 might also be run from a server computer systems system that can be accessed by a plurality of client computer systems interconnected over an intranet network. Finally, the curriculum graph database system 100 and process 200 may be run from a server computer system that is accessible to clients over the Internet.

Although embodiments have been described in detail, it should be understood that various changes, substitutions, and alterations can be made herein without departing from the spirit and scope of the invention as defined by the appended claims.

What is claimed is:

1. A method comprising:
initializing a graph database providing access to one or more curriculum data and one or more learning resources;
generating one or more curriculum graphs using a curriculum graph generator, wherein generating one or more curriculum graphs using a curriculum graph generator comprises:
parsing one or more curriculum data to identify a plurality of concepts, wherein each concepts is represented as a concept node and set of related concept nodes are represented as edges;
mapping the one or more learning resources to the plurality of concepts, wherein the learning resources correlated to one or more concepts are mapped to the corresponding one or more concept nodes;
creating new concept nodes if new concepts are identified in the curriculum data or new curriculum data is provided, wherein the new concept nodes are mutually exclusive to the already created concept nodes;
correlating the learning resources to the new concept nodes and dynamically mapping the learning resources to the related one or more new concept nodes;
receiving a user input to select a learning topic including selection of at least a start concept and a goal concept related to the topic;
generating a learning path including a list of concept nodes connecting the corresponding start concept node to the goal concept node along with a list of learning resources attached to the corresponding concept nodes in the learning path, wherein the one or more learning resources associated to the concept nodes are to be completed by the user to attain mastery in the selected learning topic.

2. The method of claim 1 wherein parsing the curriculum data further comprises:
loading the one or more curriculum data and learning resources;
converting the loaded curriculum data into a structured format by breaking down the content of the curriculum data into one or more granular concept nodes.

3. A method of claim 1 wherein parsing the one or more curriculum data to identify the plurality of concepts further comprises:
analyzing content of the one or more curriculum data using natural language processing techniques to identify one or more curriculum units;
analyzing the one or more curriculum units to identify unique concepts;
creating concept nodes for each of the identified concepts if corresponding concept node is not already created;
identifying prerequisite concepts and creating nodes for unique prerequisite concepts; and
creating edges between the prerequisite concept nodes and the corresponding concept nodes.

4. The method of claim 1 wherein mapping the one more learning resources to the plurality of concepts further comprises:
analyzing the learning resources using natural language processing techniques to identify the key concepts covered in the learning resources, correlating the key concepts of the learning resources to the concept nodes, and mapping the learning resources to the one or more related concept nodes based on matching of the key concepts to the concept nodes.

5. The method of claim 1 further comprises accessing the graph database by a user via an API operatively connected to an online learning platform, wherein the user provides an input query to retrieve a learning path and associated one or more learning resources related to the one or more concept nodes included in the learning path.

6. The method of claim 1 wherein the graph database provides access to one or more curriculum graphs, wherein each curriculum graph represents an educational topic such that the curriculum graph includes one or more concept nodes related to the educational topic and related concept nodes are joined through edges thereby allowing navigation between connected nodes.

7. The method of claim 1 wherein the curriculum data is aligned to one or more educational standards including Common Core State Standards (CCSS), Next Generation Science Standards (NGSS), and Advanced Placement (AP).

8. The method of claim 1 wherein the one or more learning resources comprise textbooks, chapters, articles, videos, audio content, and online courses.

9. The method of claim 1 further comprises:
receiving one or more user inputs through a user interface, wherein the one or more user inputs include learning objectives, start and goal concepts, one or more user preferences, and the progress made by the user on the generated learning path.

10. The method of claim 1 further comprises:
including metadata related to the one or more learning resources in the graph database for accurate and efficient mapping of the learning resources corresponding to the one or more concept nodes.

11. The method of claim 1 wherein parsing the content further comprises:
identifying one or more synonyms and related terms for the one or more identified concept nodes to enhance concept coverage and understanding;
standardizing the identified concept nodes to ensure consistency and accuracy in the representation of the curriculum data;
generating prerequisite relationships between one or more concept nodes to create a connected and navigable curriculum graph.

12. The method of claim 1 employs machine learning algorithms to evaluate and dynamically adjust the learning path to include or exclude one or more concept nodes based on user's learning progress, user preferences and feedback.

13. The method of claim 1 wherein navigating the learning path further comprises:
determining a chronological order of the one or more learning resources associated with the list of concept nodes within the learning path;
dynamically adjusting the order of learning resources presented to the user based on the user's interaction and progress on the learning path;
utilizing machine learning techniques to analyze the user's learning progress; and
automatically selecting and presenting one or more corresponding learning resources based on the user's learning level, thereby facilitating comprehensive understanding and mastery of each concept related to the selected topic.

14. The method of claim 1 further updates the curriculum graph, wherein updating the curriculum graph comprises:
tracking user's progress and performance on the learning path to adapt to one or more personalized feedbacks based on individual learning styles and abilities;
utilizing natural language processing techniques to interpret one or more user queries and refine search results for concept nodes retrieval;
incorporating a feedback mechanism to gather one or more user inputs on the relevance and effectiveness of recommended learning resources for continuous improvement.

15. A system comprising:
a graph database including data related to one or more curriculum and learning resources;
an online learning platform, operatively coupled to the graph database, having a user interface that allows communication between a user and the graph database;
an initialization module integrated within the learning platform configured to establish a digital connection between the online learning platform and the graph database;
a curriculum graph generator configured to generate one or more curriculum graphs comprises:
a parsing module to parse the curriculum data to identify a plurality of concepts, wherein each concept is represented as a node and set of related nodes are represented as edges;
a mapping module to map the one or more learning resources to the plurality of concepts, wherein the learning resources correlated to one or more concepts are mapped to the corresponding one or more concept nodes;
a learning path generator to generate a learning path related to a learning topic, wherein the learning path generator is configured to:
receive a user input via the user interface of the online learning platform, wherein the user input includes a learning topic along with a start concept and a goal concept related to the learning topic;
identify a list of concept nodes connecting the start concept node to the end concept node along with a list of learning resources attached to the corresponding concepts nodes;
generate the learning path including one or more concept nodes from the list of identified concepts, wherein the learning path includes one or more learning resources associated to the concept nodes included in the learning path such that the learning resources are to be completed by the user to attain mastery in the selected learning topic.

16. The system of claim 15 wherein a machine learning algorithm determines a chronological order of the list of resources that are to be displayed to the user for navigating through the concept nodes to achieve mastery in the selected learning topic.

17. The system of claim 15 wherein the order of one or more learning resources is dynamically adjusted based on user's interaction and progress made on the learning path, thereby providing personalized and adaptive learning to the user.

18. The system of claim 15 further comprises:
a content upgradation module configured to supplement the graph database with multimedia resources related to one or more concepts to ensure enhanced learning experience for the user.

19. The system of claim 15 further comprises conducting assessments at regular intervals to evaluate user performance and mastery of each concept.

20. The system of claim 15 wherein one or more concepts are periodically updated based on one or more learning resources and one or more curriculum data to ensure relevance and alignment of the curriculum graph with corresponding curriculum and educational standards.
